(19) United States
(12) Patent Application Publication
(10) Pub. No.: US 2025/0081010 A1
(43) Pub. Date: Mar. 6, 2025

(54) GROUP MACHINE LEARNING (ML) MODELS ACROSS A RADIO ACCESS NETWORK

(71) Applicant: Nokia Solutions and Networks Oy, Espoo (FI)

(72) Inventors: Anand BEDEKAR, Glenview, IL (US); Vaibhav SINGH, Bangalore (IN); Shivanand KADADI, Bangalore (IN); Claudiu MIHAILESCU, Massy (FR); Dora BOVIZ, Massy (FR); Jun HE, Hangzhou (CN)

(21) Appl. No.: 18/728,194

(22) PCT Filed: Jan. 14, 2022
(86) PCT No.: PCT/US2022/012545

§ 371 Date: Jul. 11, 2024

(51) Int. Cl. H04W 24/08; H04W 24/02

(52) U.S. Cl. CPC H04W 24/08; H04W 24/02

(57) ABSTRACT

Systems, methods, and software for a Radio Access Network (RAN). In one embodiment, a system identifies a plurality of cells within the RAN, and groups the cells into cell groups. The system performs a training process to train group Machine-Learning (ML) models for the cell groups based on training data for the cell groups, and evaluates a performance of the group ML models for the cell groups based on evaluation data for the cell groups. The system provides the group ML models for the cell groups to a RAN management system or the like when the performance of the group ML models satisfies a performance threshold.

### TECHNICAL FIELD

This disclosure is related to the field of communication systems and, in particular, to radio access networks.

### BACKGROUND

A Radio Access Network (RAN) is part of a mobile communication system that interacts with mobile devices (e.g., User Equipment (UE)) via a radio access technology to connect the mobile devices with a core network to receive services. A RAN includes a plurality of base stations or Base Transceiver Stations (BTS) that provide coverage to the mobile devices over a geographic area. The base stations include equipment configured to interface with mobile devices via the air interface, such as antennas, transmitters, receivers, etc., and equipment configured to interface with the core network, such as routers, controllers, etc. The geographic area served by the RAN is typically partitioned into smaller regions referred to as sectors, and the goal of a carrier is to provide adequate coverage for each sector. Thus, one or more base stations are typically located at edges of the sectors, and directional antennas of one or more base stations are directed toward each sector of the RAN. A directional antenna of a base station forms a cell within the RAN, which is a radio coverage area created by transmission and reception of Radio Frequency (RF) signals.

One issue for carriers is to provide efficient operation and optimal use of resources within the RAN.

### SUMMARY

Described herein are enhanced mechanisms for managing a RAN. Machine Learning (ML) models may be used to optimize performance within a RAN. For example, a global ML model may be generated for a RAN, and used for load prediction, spectral efficiency prediction, energy savings, or other optimization techniques. However, cells of a RAN may have large differences in characteristics, and a global ML model may not provide the desired RAN enhancement on a cell-by-cell basis. Further, the size of the global ML model and the total data from all cells that has to be accumulated for training could be prohibitively large. Thus, a system as described herein clusters cells of a RAN into cell groups. For example, the system may determine a similarity between cells of the RAN, and group the cells together into cell groups based on similarity. The system then trains an ML model for each of the cell groups. One technical benefit is an ML model is focused on a cell group, and the ML model is more likely to optimize performance for that cell group. Another benefit is the amount of training data needed to train each ML model is reduced as compared to training a global ML model, which saves training time and compute/memory resources needed for training.

One embodiment comprises a system that operates with a RAN. The system comprises at least one processor, and at least one memory including computer program code. The processor causes the system at least to identify a plurality of cells within the RAN, group the cells into cell groups, perform a training process to train group ML models for the cell groups based on training data for the cell groups, evaluate a performance of the group ML models for the cell groups based on evaluation data for the cell groups, and provide the group ML models for the cell groups to a RAN management system when the performance of the group ML models satisfies a performance threshold.

In one embodiment, the processor causes the system at least to receive cell information for the cells, generate feature vectors for the cells based on the cell information, compare the feature vectors for the cells, and group the cells into the cell groups based on a similarity of the feature vectors for the cells.

In one embodiment, the processor causes the system at least to re-group the cells into revised cell groups when the performance of a group ML model for one or more of the cell groups does not satisfy the performance threshold.

In one embodiment, the processor causes the system at least to divide the cells of a cell group into smaller cell groups when the performance of a group ML model for the cell group does not satisfy the performance threshold.

In one embodiment, the processor causes the system at least to request a policy, and group the cells into the cell groups based on the policy.

In one embodiment, the processor causes the system at least to identify a new cell within the RAN, identify a subset of the cell groups that are closest in similarity to the new cell, perform the training process to re-train the group ML models for the subset of the cell groups based on the training data that includes data for the new cell, evaluate the performance of the group ML models for the subset of the cell groups based on the evaluation data, and select a cell group for the new cell among the cell groups in the subset based on the performance of the group ML models.

In one embodiment, the system is implemented in a RAN Intelligent Controller (RIC) of an open-RAN compliant RAN architecture.

In one embodiment, the system is implemented in a gNB Central Unit (gNB CU) of an open-RAN compliant RAN architecture.

One embodiment comprises a method operable for a RAN. The method comprises identifying a plurality of cells within the RAN, grouping the cells into cell groups, performing a training process to train group ML models for the cell groups based on training data for the cell groups, evaluating a performance of the group ML models for the cell groups based on evaluation data for the cell groups, and providing the group ML models for the cell groups to a RAN management system when the performance of the group ML models satisfies a performance threshold.

In one embodiment, grouping the cells into cell groups comprises receiving cell information for the cells, generating feature vectors for the cells based on the cell information, comparing the feature vectors for the cells, and grouping the cells into the cell groups based on a similarity of the feature vectors for the cells.

In one embodiment, the method further comprises re-grouping the cells into revised cell groups when the performance of a group ML model for one or more of the cell groups does not satisfy the performance threshold.

In one embodiment, the method further comprises dividing the cells of a cell group into smaller cell groups when the performance of a group ML model for the cell group does not satisfy the performance threshold.

In one embodiment, grouping the cells into cell groups comprises requesting a policy, and grouping the cells into the cell groups based on the policy.

In one embodiment, the method further comprises identifying a new cell within the RAN, identifying a subset of the cell groups that are closest in similarity to the new cell, performing the training process to re-train the group ML models for the subset of the cell groups based on the training data that includes data for the new cell, evaluating the performance of the group ML models for the subset of the cell groups based on the evaluation data, and selecting a cell group for the new cell among the cell groups in the subset based on the performance of the group ML models.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a communication system in an illustrative embodiment.

FIG. 2 illustrates a geographic area served by a RAN in an illustrative embodiment.

FIG. 3 illustrates a base station in an illustrative embodiment.

FIG. 4 is a block diagram of a Cell Group Model Management (CGMM) system in an illustrative embodiment.

FIG. 5 is a flow chart illustrating a method of generating group ML models in an illustrative embodiment.

FIG. 6 illustrates cell groups in an illustrative embodiment.

FIG. 7 is a flow chart illustrating a method of grouping cells of a RAN into cell groups in an illustrative embodiment.

FIG. 8 is a block diagram of an ML trainer in an illustrative embodiment.

FIG. 9 illustrates a group ML model generated for each cell group in an illustrative embodiment.

FIG. 10 illustrates a re-grouping of cells in an illustrative embodiment.

FIG. 11 illustrates a cell group divided into smaller cell groups in an illustrative embodiment.

FIG. 12 is a flow chart illustrating additional steps for the method in FIG. 5 in an illustrative embodiment.

FIG. 13 is a flow chart illustrating a method of adding a new cell to a cell group in an illustrative embodiment.

FIG. 14 is a block diagram of an open-RAN (O-RAN) compliant RAN architecture in an illustrative embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

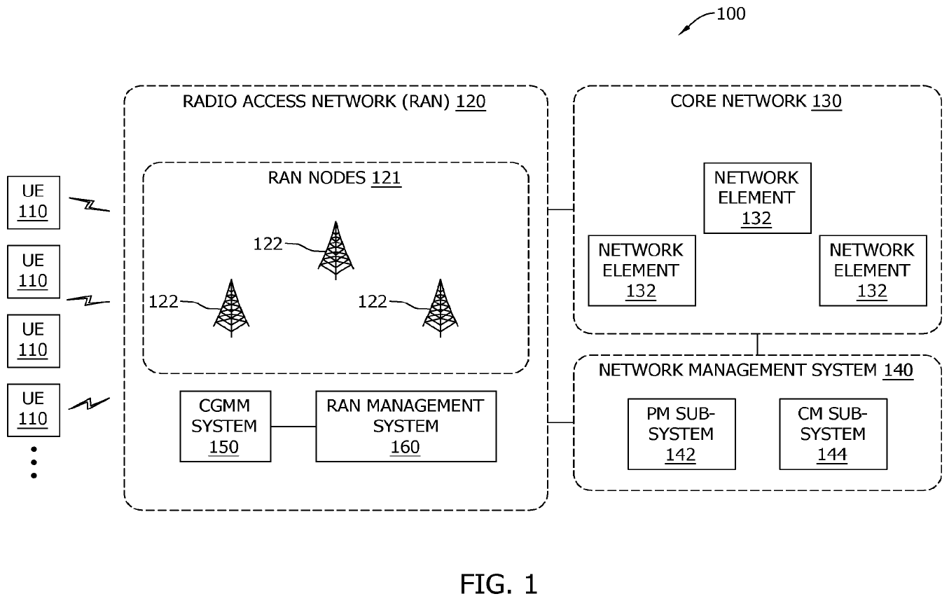

FIG. 1 illustrates a communication system 100 in an illustrative embodiment. Communication system 100 is a cellular network or mobile network where the last link is wireless, and provides voice and/or data services to a plurality of devices. Communication system 100 may be a Fourth Generation (4G) network (e.g., a Long Term Evolution (LTE) network), a next-generation network (e.g., 5G or later), or another type of network. Communication system 100 is illustrated as providing communication services to User Equipment (UE) 110. UEs 110 may be enabled for voice services, data services, Machine-to-Machine (M2M) or Machine Type Communications (MTC) services, and/or other services. A UE 110 may be an end user device such as a mobile phone (e.g., smart phone), a tablet or PDA, a computer with a mobile broadband adapter, etc. A UE 110 may be referred to generally herein as a “user”.

Communication system 100 includes one or more Radio Access Networks (RAN) 120 that communicate with UEs 110 over a radio interface. RAN 120 may support Evolved-UMTS Terrestrial Radio Access Network (E-UTRAN) access, Wireless Local Area Network (WLAN) access, new Radio Access Technologies (RAT), etc. As an example, RAN 120 may comprise an E-UTRAN or Next Generation RAN (NG-RAN). RAN 120 includes a plurality of RAN nodes 121 that communicate with UEs 110, such as base stations 122 that are dispersed over a geographic area. A base station 122 comprises an entity that uses radio communication technology to communicate with a UE 110, and interface the UE 110 with a core network 130. As described above, a base station 122 includes equipment configured to interface with UEs 110 via the air interface, such as antennas, transmitters, receivers, etc., and equipment configured to interface with core network 130, such as routers, controllers, etc. One or more of base stations 122 may communicate on the licensed spectrum, and one or more of the base stations 122 may communicate on an unlicensed spectrum. In one embodiment, one or more of base stations 122 may comprise an Evolved-NodeB (eNodeB or eNB) of an E-UTRAN. In another embodiment, one or more of base stations 122 may comprise a gNodeB (NR base stations) and/or ng-eNodeB (LTE base stations supporting a 5G Core Network) of an NG-RAN.

Core network 130 is the central part of communication system 100 that provides various services to customers who are connected by RAN 120. One example of core network 130 is the Evolved Packet Core (EPC) network as suggested by the 3GPP for LTE. Another example of core network 130 is a 5G core network as suggested by the 3GPP. Core network 130 includes network elements 132, which may comprise servers, devices, apparatus, or equipment (including hardware) that provide services for UEs 110. Network elements 132, in an EPC network, may comprise a Mobility Management Entity (MME), a Serving Gateway (S-GW), a Packet Data Network Gateway (P-GW), etc. Network elements 132, in a 5G network, may comprise an Access and Mobility Management Function (AMF), a Session Management Function (SMF), a Policy Control Function (PCF), an Application Function (AF), a User Plane Function (UPF), etc.

Communication system 100 further includes a network management system (NMS) 140. Network management system 140 is a system that monitors, maintains, and manages RAN 120 and/or core network 130, and provides functionality for a network operator to view and manage the operation of RAN 120 and/or core network 130. Network management system 140 includes a performance management (PM) sub-system 142 and a configuration management (CM) sub-system 144. Performance management sub-system 142 is configured to collect performance indicators or metrics (i.e., Key Performance Indicators (KPI)) from RAN 120 and/or core network 130. Configuration management sub-system 144 is configured to monitor, update, and report network configuration parameters to RAN 120 and/or core network 130.

RAN nodes 121 as described herein are configured to use ML models for proactive radio resource management actions for the cells. In this embodiment, communication system 100 further includes a Cell Group Model Management (CGMM) system 150. CGMM system 150 comprises a server, device, apparatus, equipment (including hardware), application, etc., configured to generate ML models for groups of cells within RAN 120. As will be described in more detail below, CGMM system 150 partitions or arranges cells of RAN 120 into cell groups, such as based on characteristics of the cells. CGMM system 150 generates or trains ML models for the cell groups, which are referred to generally as group ML models. A group ML model is an ML model that describes a relationship between certain inputs and certain outputs for a group of cells (i.e., a subset of cells). The group ML model may be used to recognize patterns, make decisions, make predictions, etc., for the group of cells. For example, RAN nodes 121 which host cells in a given group of cells may use a group ML model for that group of cells for performing proactive radio resource management actions for the cells. CGMM system 150 may be implemented on a platform within RAN 120 as illustrated in FIG. 1. However, CGMM system 150 may be implemented in network management system 140 or on another platform as desired.

Also shown in communication system 100 is a RAN management system 160. RAN management system 160 comprises a server, device, apparatus, equipment (including hardware), application, etc., configured to manage RAN 120 or cells within RAN 120 based on one or more group ML models generated by CGMM system 150. For example, RAN management system 160 may perform load management or traffic steering, Quality of Experience (QoE) Optimization, Quality of Service (QoS) Based Resource Optimization, MIMO (multiple-input, multiple-output) Optimization, etc., based on group ML models. In one embodiment, RAN management system 160 may comprise a RAN optimization system that operates based on one or more group ML models. For example, a RAN optimization system may comprise a Radio Resource Management (RRM) optimization system that implements an RRM optimization algorithm based on a group ML model, such as for load prediction, spectral efficiency prediction, energy savings, etc. RAN management system 160 may be implemented on a platform within RAN 120 as illustrated in FIG. 1, and configured to deploy group ML models to RAN nodes 121. In one embodiment, RAN management system 160 may be implemented at the RAN nodes 121. In one embodiment, RAN management system 160 may be implemented in network management system 140 or on another platform as desired.

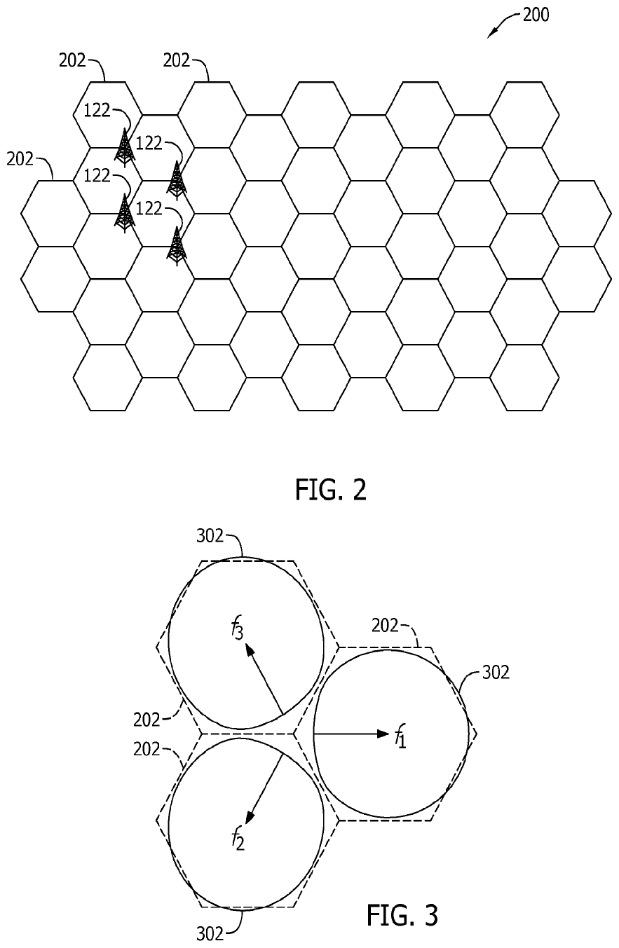

FIG. 2 illustrates a geographic area 200 served by RAN 120 in an illustrative embodiment. Geographic area 200 is partitioned into smaller regions referred to as sectors 202 (illustrated as hexagons). In this embodiment, base stations 122 are located at edges of the sectors 202 so that a cell of one or more of the base stations 122 provides coverage for at least a portion of a sector 202. It is noted that a subset of base stations 122 is shown in FIG. 2 for brevity, and RAN 120 may include more base stations 122 to provide adequate coverage over the entirety of geographic area 200.

FIG. 3 illustrates a base station 122 in an illustrative embodiment. In this embodiment, base station 122 may have transceiver equipment that serves three sectors 202 and forms three cells 302. For example, base station 122 may include three directional antennas that each provides 120-degrees coverage to form cells 302. However, the implementation shown in FIG. 3 is just an example, and a base station 122 may form a different number of cells 302 in other embodiments. Each cell 302 of base station 122 may operate using a different carrier frequency (e.g., carrier frequency f₁, carrier frequency f₂, and carrier frequency f₃).

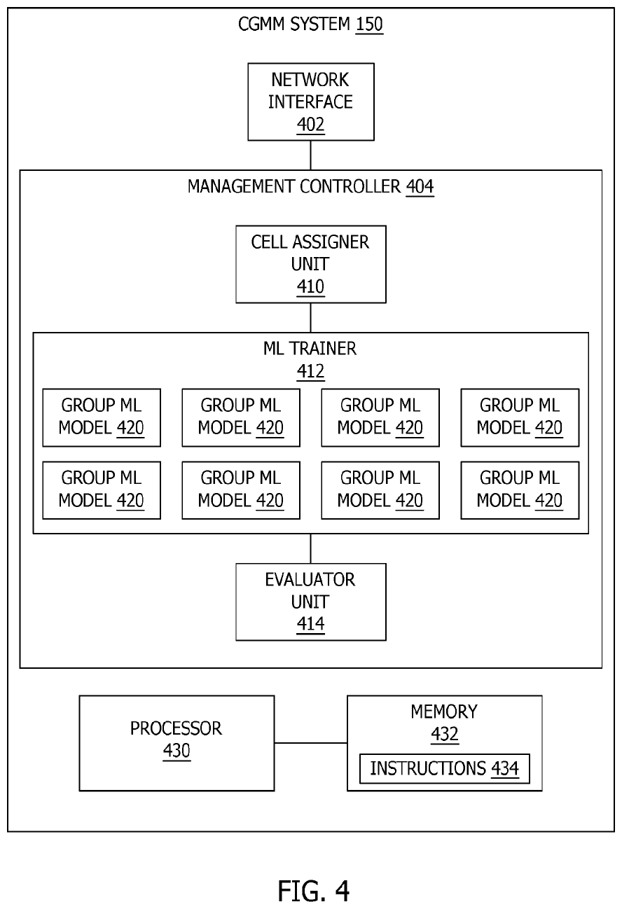

FIG. 4 is a block diagram of CGMM system 150 in an illustrative embodiment. In this embodiment, CGMM system 150 includes the following subsystems: a network interface component 402 and a management controller 404. Network interface component 402 is a hardware component or circuitry that exchanges messages, signaling, packets, data, etc., with other elements over a network connection. Network interface component 402 may use a variety of protocols or reference points for communication. Management controller 404 comprises circuitry, logic, hardware, means, etc., configured to generate group ML models for groups of cells within RAN 120. In one embodiment, management controller 404 implements a cell assigner unit 410, an ML trainer 412, and an evaluator unit 414. Cell assigner unit 410 is configured to assign cells of RAN 120 to cell groups. ML trainer 412 is configured to train group ML models 420 for the cell groups, or to interact with a training module to assist in training group ML models 420 for the cell groups. Evaluator unit 414 is configured to evaluate the performance of the group ML models 420 for the cell groups.

One or more of the subsystems of CGMM system 150 may be implemented on a hardware platform comprised of analog and/or digital circuitry. One or more of the subsystems of CGMM system 150 may be implemented on a processor 430 that executes instructions 434 stored in memory 432. A processor 430 comprises an integrated hardware circuit configured to execute instructions 434 to provide the functions of CGMM system 150. Processor 430 may comprise a set of one or more processors or may comprise a multi-processor core, depending on the particular implementation. Memory 432 is a non-transitory computer readable medium for data, instructions, applications, etc., and is accessible by processor 430. Memory 432 is a hardware storage device capable of storing information on a temporary basis and/or a permanent basis. Memory 432 may comprise a random-access memory, or any other volatile or non-volatile storage device.

CGMM system 150 may include various other components not specifically illustrated in FIG. 4.

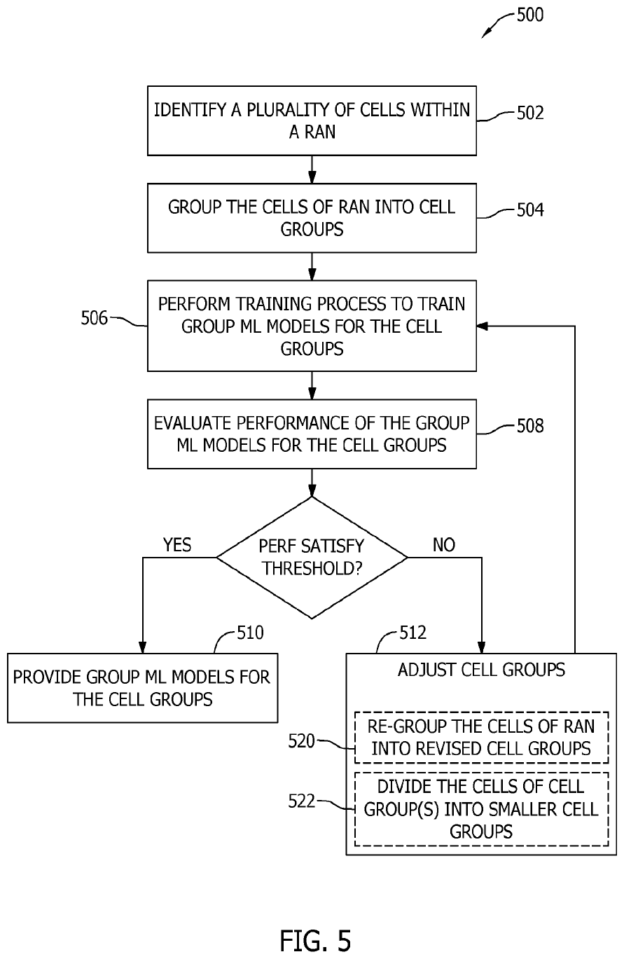

FIG. 5 is a flow chart illustrating a method 500 of generating group ML models 420 in an illustrative embodiment. The steps of method 500 will be described with reference to CGMM system 150 in FIG. 4, but those skilled in the art will appreciate that method 500 may be performed in other systems, devices, or network functions. The steps of the flow charts described herein are not all inclusive and may include other steps not shown, and the steps may be performed in an alternative order.

For method 500, cell assignor unit 410 identifies a plurality of cells 302 within RAN 120 (step 502). For example, cell assignor unit 410 may communicate with a RAN node 121, network management system 140, and/or another system to request cell information about the cells 302. Cell information comprises any information or data related to a cell 302. The cell information may include performance metrics KPI, such as a number of connected users (or counter of leaving/entering users), a number of active users, a number of bearers, Downlink (DL) or Uplink (UL) Physical Resource Block (PRB) utilization, Physical Downlink Control Channel (PDCCH) utilization, Physical Uplink Control Channel (PUCCH) utilization, composite available capacity, total data delivered or received at a RAN node, etc. The cell information may include a cell identifier, resource capabilities, such as compute and memory resources for a cell 302, and/or any other desired information or attributes regarding a cell 302.

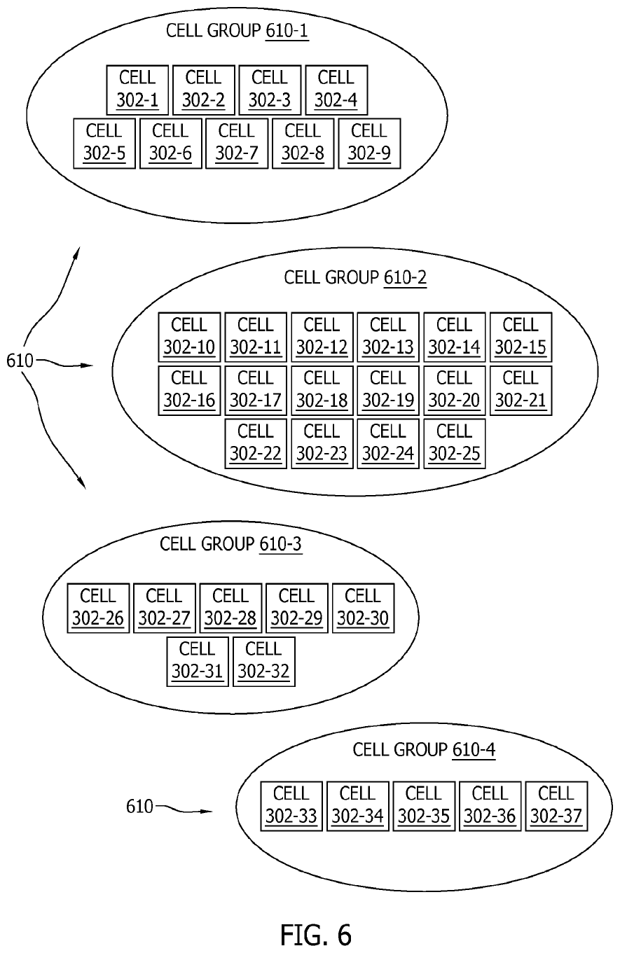

Cell assignor unit 410 groups, assembles, divides, segments, or partitions the cells 302 of RAN 120 into cell groups (step 504). Cell assignor unit 410 may form cell groups from the cells 302 that are targeted to share a group ML model 420. In one embodiment, cell assignor unit 410 may process the cell information for the cells 302 in grouping the cells 302 together into cell groups. FIG. 6 illustrates cell groups 610 in an illustrative embodiment. Each cell group 610 comprises a plurality of cells 302 (although it is possible for a cell group 610 to comprise a single cell 302). The cells 302 of a cell group 610 have similar cell characteristics so that a group ML model 420 will be applicable to the cell group 610. In one embodiment, a cell 302 belongs exclusively to one of the cell groups 610.

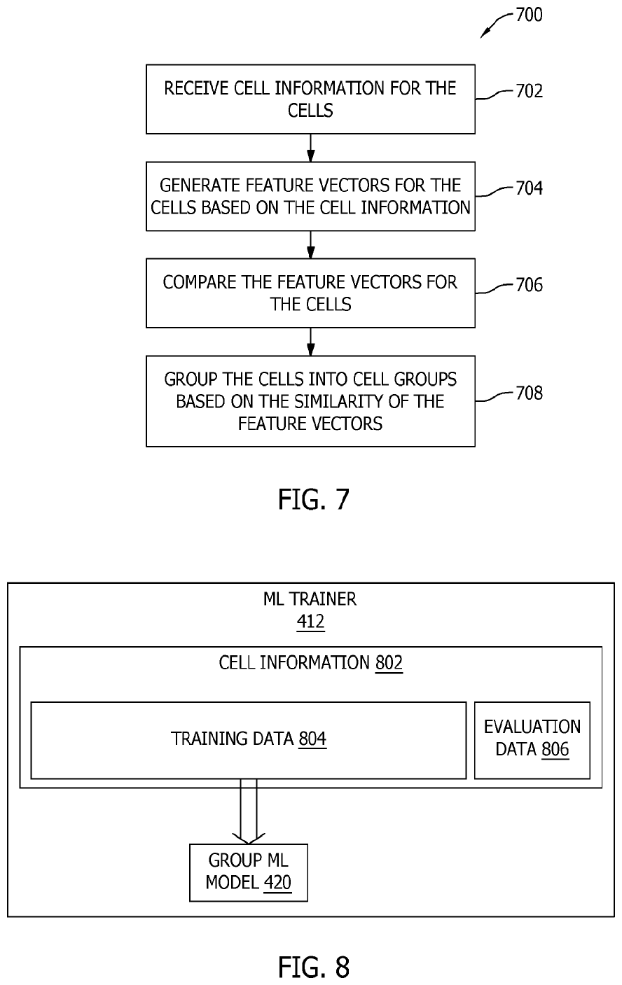

Cell assignor unit 410 may use a variety of procedures, policies, or criteria to determine which cells 302 belong with which cell groups 610. FIG. 7 is a flow chart illustrating a method 700 of grouping the cells 302 of RAN 120 into cell groups 610 in an illustrative embodiment. For method 700, cell assignor unit 410 receives cell information for the cells 302 through network interface component 402 (step 702), and generates feature vectors for the cells 302 based on the cell information (step 704). The feature vector for a cell 302 may take into account performance metrics for the cell 302, resource capabilities at the cell 302, geographical location of the cell 302, and/or other desired cell information. For example, cell assignor unit 410 may take into account a time-series of various metrics or key performance indicators for the cell 302 when constructing the feature vector, representing the evolution or trends of the metrics or KPIs over time within the cell 302. Cell assignor unit 410 may take a time-series of load metrics in a cell 302, such as a number of connected users, a number of active users, or a number of data bytes arriving for transmission at the cell 302, where the load metric may be averaged at suitable time intervals such as one minute, fifteen minutes, or at any suitable interval. By taking such factors into account in constructing the feature vector, cell assignor unit 410 may be able to ensure that cells 302 with similar trends in KPIs or metrics may be preferably grouped together. Alternatively or additionally, cell assignor unit 410 may take distributions or histograms or density functions of various quantities, or the evolution of these distributions or histograms over time, into account when constructing the feature vectors. For example, cell assignor unit 410 may take into account the distribution of various quantities representing the radio propagation and interference conditions experienced by users in the cell 302. Cell assignor unit 410 may take into account the distribution of path loss to various users or distribution of received signal strength or power headroom reports or distribution of channel quality indicators or spectral efficiency or channel rank (for MIMO channel), or measures of user speed or mobility (such as Doppler shift estimates) or channel coherence time (representing the rapidity with which channel conditions may change within the cell), or measures of channel coherence bandwidth or delay spread of the channel, or received sounding reference signal measurements or channel covariance matrix estimates, or the number or characteristics of cell center users or cell edge users in the cell 302, or the like. By taking such measures into account, cell assignor unit 410 may be able to ensure that cells with similar spread or distribution of such channel condition-related properties may be preferably grouped together. Alternatively or additionally, cell assignor unit 410 may take into account measurements or characteristics of neighbor cells of a given cell into account when constructing the feature vector for a cell 302. For example, cell assignor unit 410 may take into account time-series and/or distributions or other measures of the activity factor or transmission likelihood or emitted power of neighbor cells, which may be a measure of the interference likely to be experienced by the users in the cell 302. Alternatively or additionally, cell assignor unit 410 may take into account properties of transmission of the cell 302 and/or its neighbor cells when constructing a feature vector, such as the number of transmit antennas, antenna heights and orientations, transmit power, carrier frequency, beam characteristics (such as beam orientations and beam widths), relative distances or orientations between transceivers (or transmit/receive points, also known as TRPs) of a cell and its neighbors, locations of the transceiver or TRPs of a cell and its neighbor cells, whether the cell and/or its neighbor cells are macro cells or small cells, or the like. Cell assignor unit 410 may take into account other characteristics of the cell or its neighbor cells that may arise from the geographic characteristics or the layout of various structures within the cells, such as indications of the number of high-rise buildings within the cell or the number of major streets or highways or train lines running through the cells, or the volume of pedestrian or automobile or train traffic, or the presence of malls or parks or concert venues or other places where high numbers of mobile terminals may be present simultaneously, or the like. Cell assignor unit 410 may also take into account the expected Quality of Service (QoS) characteristics of the users in the cell 302, or the relative volumes of traffic requesting different types of QoS at various times within the cell 302, or the like. Cell assignor unit 410 may also take into account various configuration parameters of the cell and/or its neighbor cells. Taking some or all of these factors into account may result in a very high-dimensional feature vector, so cell assignor unit 410 may also employ techniques to convert the feature vector of a cell 302 to a space with a lower or computationally tractable number of dimensions, including dimensionality reduction techniques such as principal component analysis or auto-encoders or embeddings, and treat the output of such transformations as the feature vector of the cell 302 to be used for further processing.

Cell assignor unit 410 compares the feature vectors for the cells 302 (step 706), and groups the cells 302 into cell groups 610 based on the similarity of the feature vectors for the cells 302 (step 708). Thus, similar cells 302 (i.e., cells having similar characteristics) are grouped together into the cell groups 610. For this purpose, cell assignor unit 410 may construct and utilize a similarity metric (such as a dot product) or equivalently a dissimilarity metric (such as a distance metric or a divergence metric) between feature vectors of cells 302. Based on such a similarity (or dissimilarity) metric, cell assignor unit 410 may employ various means of grouping together the cells 302 into groups, such as clustering techniques. For example, cell assignor unit 410 may use clustering techniques such as K-means to group the cells into K groups (where K is suitably chosen) in such a way that the cells 302 within each group have a sufficiently high similarity metric (or sufficiently low dissimilarity metric).

In FIG. 5, ML trainer 412 performs a training process to train group ML models 420 for the cell groups 610 based on training data for the cell groups 610 (step 506). ML trainer 412 may gather the training data for a cell group 610 from the cell information collected for the cells 302 of the cell group 610, and train a group ML model 420 for the cell group 610 based on the training data for that cell group 610. Assume, for example, that cell group 610-1 as in FIG. 6 is comprised of cells 302-1 through 302-9. ML trainer 412 collects the cell information for cells 302-1 through 302-9, and selects at least a portion of the cell information for these cells 302 as training data for that cell group 610-1. Assume further that cell group 610-2 as in FIG. 6 is comprised of cells 302-10 through 302-25. ML trainer 412 collects the cell information for cells 302-10 through 302-25, and uses at least a portion of the cell information for these cells 302 as training data for that cell group 610-2.

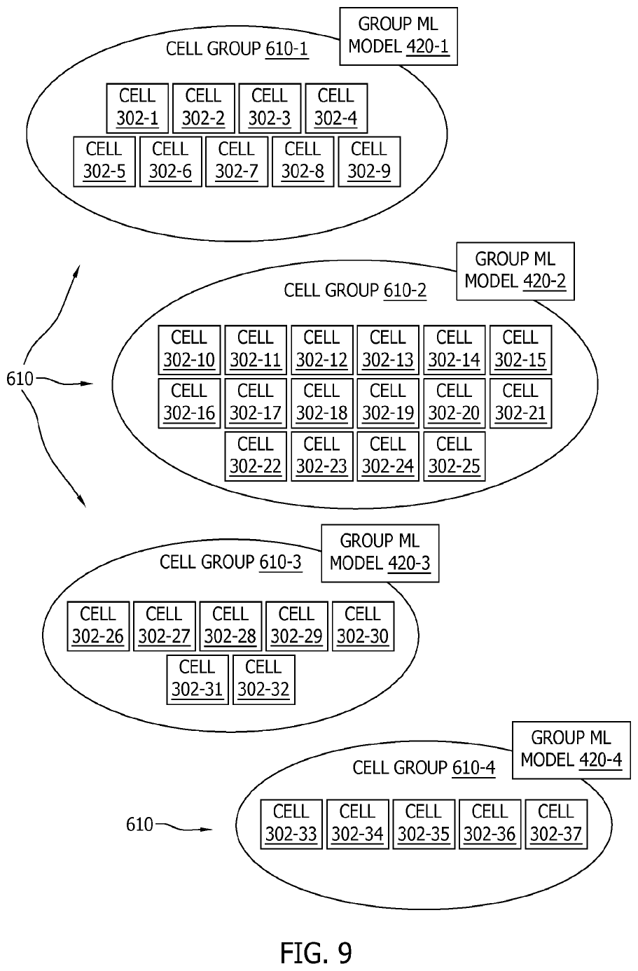

FIG. 8 is a block diagram of ML trainer 412 in an illustrative embodiment. ML trainer 412 collects cell information 802 for cells 302 of a cell group 610, and selects at least a portion of the cell information 802 for these cells 302 as training data 804 for that cell group 610. ML trainer 412 also selects a portion (e.g., the remaining portion) of the cell information 802 for these cells 302 as evaluation data 806 for that cell group 610. ML trainer 412 then performs the training process to train a group ML model 420 for the cell group 610 based on the training data 804 for the cell group 610. At the end of training, there is a group ML model 420 generated or trained for each of the cell groups 610. FIG. 9 illustrates a group ML model 420 generated for each cell group 610 in an illustrative embodiment.

In FIG. 5, with group ML models 420 trained for the cell groups 610, evaluator unit 414 determines whether the group ML models 420 satisfy criteria defined for the group ML models 420. Evaluator unit 414 evaluates the performance of the group ML models 420 for the cell groups 610 based on the evaluation data 806 for the cell groups 610 (step 508). In one embodiment, evaluator unit 414 determines whether the group ML model 420 for a cell group 610 satisfies a performance threshold based on the evaluation data 806 for that cell group 610. For example, evaluator unit 414 may perform an error analysis on the group ML model 420 to determine if the error is less than a performance threshold. In another example, evaluator unit 414 may perform an accuracy analysis on the group ML model 420 to determine if the accuracy is greater than a performance threshold. In one embodiment, evaluator unit 414 may determine whether the group ML models 420 satisfy other constraints for a cell group 610, such as compute/memory usage.

When the group ML models 420 satisfy a performance threshold, evaluator unit 414 provides the group ML model 420 for the cell group 610 to RAN management system 160 (step 510), such as through network interface component 402. For example, evaluator unit 414 may transmit a message (through network interface component 402) to RAN management system 160 that includes a copy of the group ML models 420 for the cell groups 610, identifiers for the cells 302 of the cell groups 610, etc. In another example, evaluator unit 414 may transmit a message (through network interface component 402) to RAN management system 160 that includes identifiers for the group ML models 420 for the cell groups 610, identifiers for the cells 302 of the cell groups 610, etc. Evaluator unit 414 may also upload the group ML models 420 to an ML model server or the like within RAN 120, which is accessible by RAN management system 160. The group ML model 420 for a cell group 610 may include metadata indicating identifiers for the cells 302 of the cell group 610 that are associated with the group ML model 420. RAN management system 160 may then process or consume the group ML models 420 when performing management or optimization for cells 302 of the cell group 610. RAN management system 160 may deploy the group ML models 420 to the RAN nodes 121 for the cell groups 610, thereby causing the RAN nodes 121 of a cell group 610 to use the group ML model 420 for proactive radio resource management actions for the cells 302 in the cell group 610.

When the group ML model 420 for one or more of the cell groups 610 does not satisfy the performance threshold, cell assignor unit 410 adjusts, modifies, or alters the cell groups 610 (step 512). In adjusting the cell groups 610, cell assignor unit 410 may re-group the cells 302 of RAN 120 into revised cell groups 610 (optional step 520). Again, cell assignor unit 410 may process the cell information for the cells 302 in re-grouping the cells 302 together into the revised cell groups 610. In one embodiment, cell assignor unit 410 may form the same number of groups when re-grouping the cells 302 into revised cell groups 610. In other words, the cells 302 of RAN 120 may be re-aligned among the same number (m) of groups. In one embodiment, cell assignor unit 410 may form a different number of groups when re-grouping the cells 302 into revised cell groups 610. For example, the number of cell groups 610 may go from m groups to n groups after re-grouping.

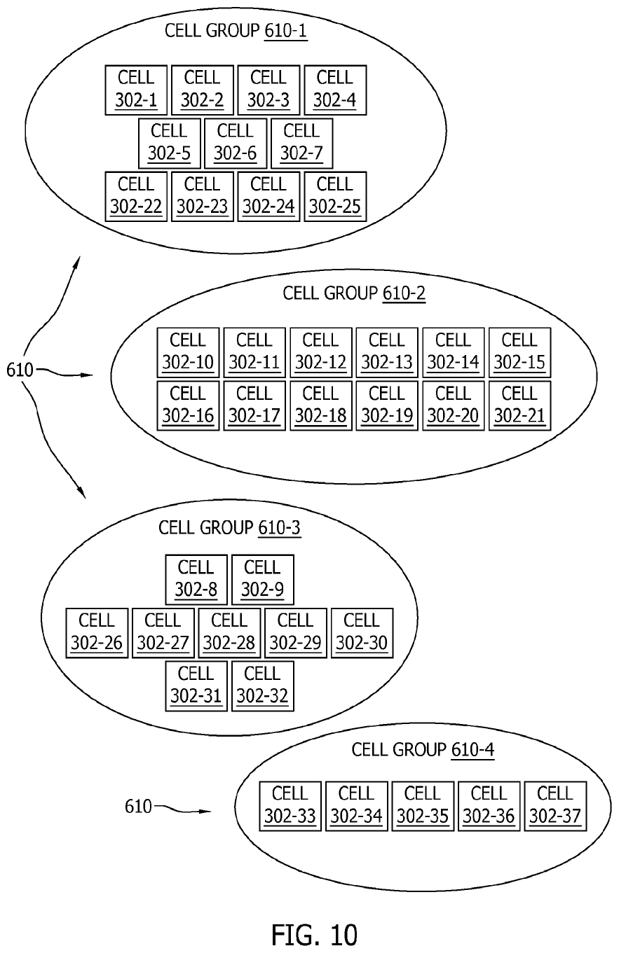

FIG. 10 illustrates a re-grouping of cells 302 in an illustrative embodiment. As a comparison to FIG. 6 where cell group 610-1 includes cells 302-1 through 302-9, revised cell group 610-1 includes cells 301-1 through 301-7, and cells 302-22 through 302-25. Further, where cell group 610-3 includes cells 302-26 through 302-32 in FIG. 6, revised cell group 610-3 includes cells 301-8 through 301-9, and cells 302-26 through 302-32. Although the same number of cell groups 610 are formed after re-grouping in FIG. 10, a different number of cell groups 610 may be formed after re-grouping.

After re-grouping the cells 302 in FIG. 5, method 500 returns to step 506 where ML trainer 412 performs a training process to train group ML models 420 for the revised cell groups 610 based on training data 804 for the revised cell groups 610.

In adjusting the cell groups 610 in step 512 of method 500, cell assignor unit 410 may divide or segment the cells 302 of an existing cell group 610 into smaller cell groups 610 (optional step 522), such as based on the cell information 802. In one embodiment, cell assignor unit 410 may divide an existing cell group 610 when the performance of the group

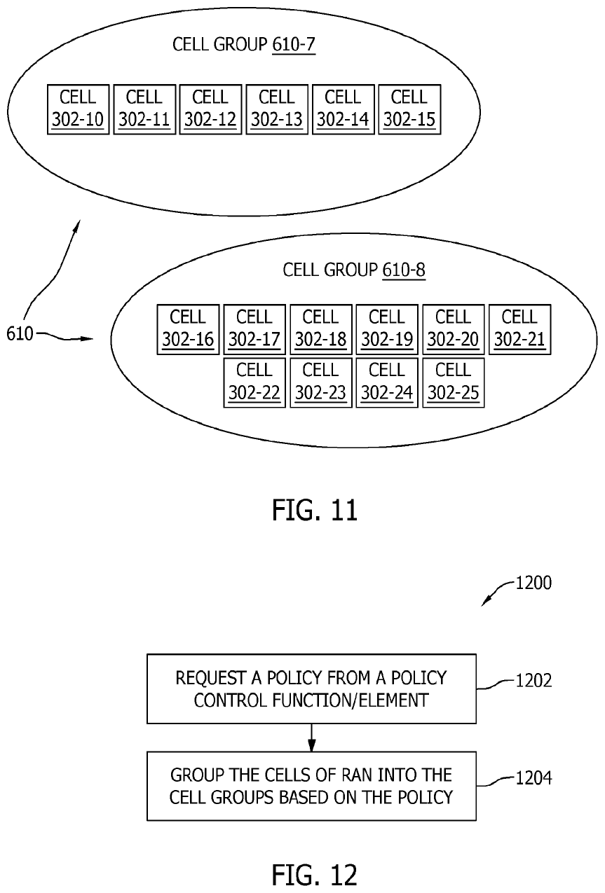

ML model 420 for that cell group 610 does not satisfy the performance threshold. Cell assignor unit 410 may leave the other cell groups 610 (i.e., the cell groups 610 having a group ML model 420 that satisfies the performance threshold) intact. FIG. 11 illustrates a cell group 610-2 (see FIG. 6) divided into smaller cell groups 610-7 and 610-8 in an illustrative embodiment. In this embodiment, cell group 610-7 includes cells 302-10 through 302-15, and cell sub-group 610-8 includes cells 302-16 through 302-25. After dividing a cell group 610, method 500 returns to step 506 where ML trainer 412 performs a training process to train group ML models 420 for the cell groups 610 based on training data 804 for the cell groups 610 (step 506).

Method 500 provides a technical benefit in that a group ML model 420 is trained for each of the cell groups 610, and a group ML model 420 is more likely to optimize performance for that cell group 610. Another benefit is the amount of training data 804 needed to train each group ML model 420 is reduced as compared to training a global ML model for RAN 120, which saves training time and compute/memory resources needed for training. The group ML models 420 are also smaller in size as compared to a global ML model for RAN 120, and requires less storage.

In one embodiment, CGMM system 150 may acquire a policy from a policy control function (e.g., PCF) when generating the group ML models 420. FIG. 12 is a flow chart illustrating additional steps for method 500 in an illustrative embodiment. Before grouping the cells 302 of RAN 120 into cell groups 610, cell assignor unit 410 may request a policy from a policy control function or policy control element (step 1202), such as a PCF of a 5G core network, a Policy/Orchestration Engine, etc. Cell assignor unit 410 may request the policy through a policy Application Programming Interface (API). The policy may define rules or constraints that are applied to a group ML model 420. For example, the policy may include indications of which cells 302 of RAN 120 are to be handled by CGMM system 150, indications of which algorithms are allowed to request a group ML model 420, biasing/priority factors for certain cells/carriers (for example, to factors that may make it more likely, or less likely, that certain cells 302 would get grouped together), biasing/priority factors/weights that may be used in defining a similarity measure between feature vectors of cells 302 or a performance measure for training of an ML model, amount of compute and memory resources for cells/cell groups, amount of compute and memory resources for CGMM system 150, biasing/priority factors for a certain RAN optimization algorithm, amount of compute and memory resources for the respective RAN optimization algorithms, minimum performance thresholds for different RAN optimization algorithms for certain cells 302, use-case features for group ML models 420, etc. Cell assignor unit 410 then groups the cells 302 of RAN 120 into the cell groups 610 based on the policy (step 1204). Cell assignor unit 410 may balance performance objectives with compute/memory overhead (i.e., constraints) based on the policy. Cell assignor unit 410 may also consider other attributes of the cells 302 when assigning the cells 302 to particular cell groups 610 based on the policy. For example, the additional attributes may include: (i) a type of characteristic based on which group ML models 420 are formed, at least one of average, maximum, a given percentile for confidence interval, trends, peak to average ratio, standard deviation and higher moments, (ii) a list of underlying input KPIs of a cell 302 that can be used to form cell group 610, at least one of a number of connected users, a number of active users, a number of bearers, DL or UL PRB utilization, PDCCH utilization, PUCCH utilization, composite available capacity, total data delivered or received at a RAN node, etc., (iii) a complexity constraint measure denoting how many cells 302 should form a particular group ML model 420, (iv) a data storage constraint measure denoting how much data can be stored for updating a group ML model 420, (v) a threshold based on number of samples required for training for a particular use-case, etc. The policy may include a performance objective, such as a performance threshold, error metrics (e.g., different error percentiles, mean error, absolute error, etc.), or other minimum performance objectives expected from a group ML model 420.

The above description provides for groupings using a “cell” as the granularity. However, it should be understood that the proposed solution may apply equally with granularity in terms other units, such as “sector”, “carrier”, “base station”, “host”, “RAN node”, “slice”, or another logical grouping in a RAN that share a group ML model 420.

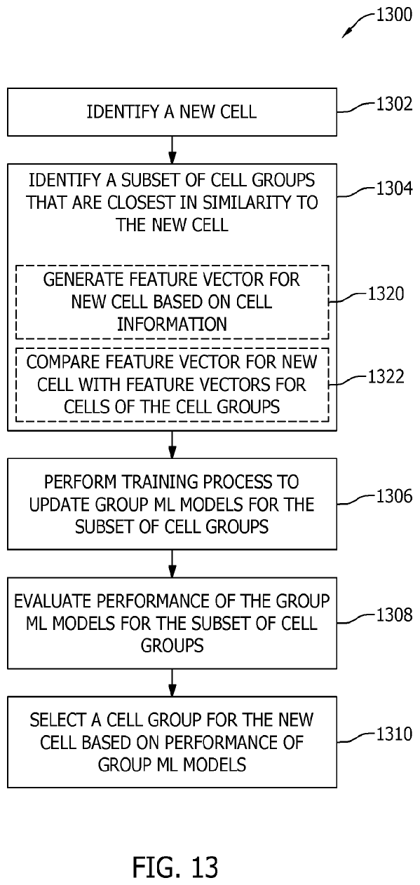

FIG. 13 is a flow chart illustrating a method 1300 of adding a new cell 302 to a cell group 610 in an illustrative embodiment. It is assumed for this embodiment that CGMM system 150 has divided cells 302 of RAN 120 into cell groups 610, and has generated a group ML model 420 for each of the cell groups 610. It is further assumed that a new cell 302 is being added or brought online for RAN 120. Cell assignor unit 410 identifies the new cell 302 (step 1302), and identifies a number or subset (K) of cell groups 610 that are closest in similarity to the new cell 302 (step 1304). For example, cell assignor unit 410 may generate a feature vector for the new cell 302 based on the cell information 802 (optional step 1320). The feature vector for the new cell 302 may take into account performance metrics for the new cell 302, resource capabilities at the new cell 302, geographical location of the new cell 302, and/or other desired cell information 802. Cell assignor unit 410 compares the feature vector for the new cell 302 with feature vectors for the cells 302 of the cell groups 610 (optional step 1322) to identify a number or subset (K) of cell groups 610 that are closest in similarity to the new cell 302. ML trainer 412 performs a training process to update or re-train the group ML models 420 for the subset of cell groups 610 (step 1306) by including the new cell 302. For example, ML trainer 412 re-trains the group ML models 420 for the subset of cell groups 610 using training data 804 that includes data for the new cell 302 (in addition to the training data 804 for the other cells 302 of the cell group 610). The re-training or updating of the group ML models 420 including the data for the new cell 302 may be done in a variety of ways. For example, ML trainer 412 may use the weights of a previously-trained group ML model 420 as the initial values for the new training, and may then run an optimization process (e.g., gradient descent) on the training data 804 including data from the new cell 302, so as to obtain faster convergence. Alternatively, ML trainer 412 may retain a subset of weights from a previously-trained group ML model 420 (for example, in the case of a neural network model, the weights of the neurons in the first L layers of a previously-trained neural network model), and only choose to update or re-train the remaining weights of the group ML model 420 (for example, the weights of the neurons in the remaining layers of a previously-trained neural network model).

Evaluator unit 414 evaluates the performance of the group ML models 420 for the subset of cell groups 610 after re-training (step 1308), such as by comparing the performance of the group ML models 420 to a performance threshold. Evaluator unit 414 selects a cell group 610 for the new cell 302, among the cell groups 610 in the subset, based on the performance of the group ML models 420 (step 1310) including the new cell 302. For example, evaluator unit 414 may identify a group ML model 420 that maximized performance when adding the new cell 302. Evaluator unit 414 may select the cell group 610 for the new cell 302 based on other criteria, such as overhead constraints. In one embodiment, evaluator unit 414 may establish a new cell group 610 for the new cell 302 when the performance and/or overhead constraints are not satisfied for the group ML models 420 after re-training.

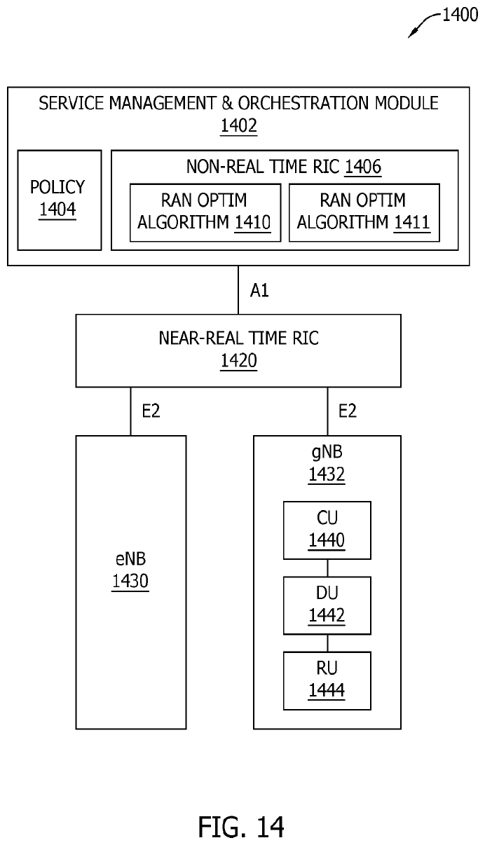

FIG. 14 is a block diagram of an open-RAN (O-RAN) compliant RAN architecture 1400 in an illustrative embodiment. O-RAN is an evolution of a Next Generation RAN (NG-RAN) architecture, such as provided by the 3GPP in TS 38.401 (v. 16.8.0), which is incorporated by reference as if fully provided herein. RAN architecture 1400 includes a Service Management and Orchestration (SMO) module 1402 configured to manage network functions. SMO module 1402 includes policy control function 1404 and a non-real-time RAN Intelligent Controller (RIC) 1406, which is a logical function that enables non-real-time control and optimization of RAN elements and resources, Artificial Intelligence (AI)/ML workflow including model training and updates, and policy-based guidance of applications/features. Non-real-time RIC 1406 may use or operate RAN optimization algorithms 1410-1411, which are configured to provide RAN management based on ML models.

RAN architecture 1400 further includes a near-real time RIC 1420, which is a logical function that enables near-real-time control and optimization of O-RAN elements and resources via fine-grained data collection and actions. RAN architecture 1400 further includes an eNB 1430 and a gNB 1432. In this example, gNB 1432 includes a gNB Central Unit (gNB CU) 1440 (may also be referred to as an O-RAN Central Unit (O-CU)), which is a logical node that includes the gNB functions like transfer of user data, mobility control, radio access network sharing, positioning, session management, etc. The gNB CU 1440 may host Radio Resource Control (RRC), Service Data Adaption Protocol (SDAP), and Packet Data Convergence Protocol (PDCP) of a gNB 1432, or RRC and PDCP of the en-gNB that controls the operation of one or more gNB Distributed Units (gNB DUs). Although not shown, gNB CU 1440 may be comprised of a CU-CP, which is a logical node hosting the RRC and the control plane part of the PDCP protocol of the gNB CU 1440 for an en-gNB or a gNB 1432, and a CU-UP, which is a logical node hosting the user plane part of the PDCP protocol of the gNB CU 1440 for an en-gNB, and the user plane part of the PDCP protocol and the SDAP protocol of the gNB CU 1440 for a gNB 1432.

RAN architecture 1400 further includes a gNB Distributed Unit (gNB DU) 1442 (may also be referred to as an O-RAN Distributed Unit (O-DU)), which is a logical node that includes a subset of the gNB functions, depending on the functional split option, and its operation is controlled by the gNB CU 1440. The gNB DU 1442 may host Radio Link Control (RLC), Medium Access Control (MAC), and Physical (PHY) layers of the gNB 1432 or en-gNB. RAN architecture 1400 further includes a gNB Radio Unit (gNB RU) 1444, which is a logical node hosting Low-PHY layer and Radio Frequency (RF) processing based on a lower layer functional split.

In one embodiment, CGMM system 150 as described above may be implemented in non-real time RIC 1406. In one embodiment, CGMM system 150 may be implemented in near-real time RIC 1420, or other elements of RAN architecture 1400, such as gNB CU 1440 or gNB DU 1442.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

As used in this application, the term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory (ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although specific embodiments were described herein, the scope of the disclosure is not limited to those specific embodiments. The scope of the disclosure is defined by the following claims and any equivalents thereof.

1-20. (canceled)

21. A system (150) that operates with a Radio Access Network (RAN) (120), the system comprising:
at least one processor (430); and
at least one memory (432) including computer program code;
the at least one memory and the computer program code configured to, with the at least one processor, cause the system at least to:
identify a plurality of cells (302) within the RAN;
group the cells into cell groups (610);
perform a training process to train group Machine-Learning (ML) models (420) for the cell groups based on training data (804) for the cell groups;
evaluate a performance of the group ML models for the cell groups based on evaluation data (806) for the cell groups; and
provide the group ML models for the cell groups to a RAN management system (160) when the performance of the group ML models satisfies a performance threshold.

22. The system of claim 21 wherein the at least one memory and the computer program code configured to, with the at least one processor, cause the system at least to:
receive cell information (802) for the cells;
generate feature vectors for the cells based on the cell information;
compare the feature vectors for the cells; and
group the cells into the cell groups based on a similarity of the feature vectors for the cells.

23. The system of claim 21 wherein the at least one memory and the computer program code configured to, with the at least one processor, cause the system at least to:
re-group the cells into revised cell groups when the performance of a group ML model for one or more of the cell groups does not satisfy the performance threshold.

24. The system of claim 21 wherein the at least one memory and the computer program code configured to, with the at least one processor, cause the system at least to:
divide the cells of a cell group into smaller cell groups when the performance of a group ML model for the cell group does not satisfy the performance threshold.

25. The system of claim 21 wherein the at least one memory and the computer program code configured to, with the at least one processor, cause the system at least to:
request a policy; and
group the cells into the cell groups based on the policy.

26. The system of claim 21 wherein the at least one memory and the computer program code configured to, with the at least one processor, cause the system at least to:
identify a new cell within the RAN;
identify a subset of the cell groups that are closest in similarity to the new cell;
perform the training process to re-train the group ML models for the subset of the cell groups based on the training data that includes data for the new cell;
evaluate the performance of the group ML models for the subset of the cell groups based on the evaluation data; and
select a cell group for the new cell among the cell groups in the subset based on the performance of the group ML models.

27. The system of claim 21 wherein:
the system is implemented in a RAN Intelligent Controller (RIC) (1406) of an open-RAN compliant RAN architecture (1400).

28. The system of claim 21 wherein:
the system is implemented in a gNB Central Unit (gNB CU) (1440) of an open-RAN compliant RAN architecture (1400).

29. A method (500) operable for a Radio Access Network (RAN), the method comprising:
identifying (502) a plurality of cells within the RAN;
grouping (504) the cells into cell groups;
performing (506) a training process to train group Machine-Learning (ML) models for the cell groups based on training data for the cell groups;
evaluating (508) a performance of the group ML models for the cell groups based on evaluation data for the cell groups; and
providing (510) the group ML models for the cell groups to a RAN management system when the performance of the group ML models satisfies a performance threshold.

30. The method of claim 29 wherein grouping the cells into cell groups comprises:
receiving (702) cell information for the cells;
generating (704) feature vectors for the cells based on the cell information;
comparing (706) the feature vectors for the cells; and
grouping (708) the cells into the cell groups based on a similarity of the feature vectors for the cells.

31. The method of claim 29 further comprising:
re-grouping (520) the cells into revised cell groups when the performance of a group ML model for one or more of the cell groups does not satisfy the performance threshold.

32. The method of claim 29 further comprising:
dividing (522) the cells of a cell group into smaller cell groups when the performance of a group ML model for the cell group does not satisfy the performance threshold.

33. The method of claim 29 wherein grouping the cells into cell groups comprises:
requesting (1202) a policy; and
grouping (1204) the cells into the cell groups based on the policy.

34. The method of claim 29 further comprising:
identifying (1302) a new cell within the RAN;
identifying (1304) a subset of the cell groups that are closest in similarity to the new cell;
performing (1306) the training process to re-train the group ML models for the subset of the cell groups based on the training data that includes data for the new cell;
evaluating (1308) the performance of the group ML models for the subset of the cell groups based on the evaluation data; and
selecting (1310) a cell group for the new cell among the cell groups in the subset based on the performance of the group ML models.

35. A non-transitory computer readable medium (432) embodying programmed instructions (434) executed by a processor (430), wherein the instructions direct the processor to implement a method operable for a Radio Access Network (RAN), the method comprising:
identifying a plurality of cells within the RAN;
grouping the cells into cell groups;
performing a training process to train group Machine-Learning (ML) models for the cell groups based on training data for the cell groups;
evaluating a performance of the group ML models for the cell groups based on evaluation data for the cell groups; and
providing the group ML models for the cell groups to a RAN management system when the performance of the group ML models satisfies a performance threshold.

36. The computer readable medium of claim 35 wherein grouping the cells into cell groups comprises:
receiving cell information for the cells;
generating feature vectors for the cells based on the cell information;
comparing the feature vectors for the cells; and
grouping the cells into the cell groups based on a similarity of the feature vectors for the cells.

37. The computer readable medium of claim 35 wherein the method further comprises:
re-grouping the cells into revised cell groups when the performance of a group ML model for one or more of the cell groups does not satisfy the performance threshold.

38. The computer readable medium of claim 35 wherein the method further comprises:
dividing the cells of a cell group into smaller cell groups when the performance of a group ML model for the cell group does not satisfy the performance threshold.

39. The computer readable medium of claim 35 wherein grouping the cells into cell groups comprises:
requesting a policy; and
grouping the cells into the cell groups based on the policy.

40. The computer readable medium of claim 35 wherein the method further comprises:
identifying a new cell within the RAN;
identifying a subset of the cell groups that are closest in similarity to the new cell;
performing the training process to re-train the group ML models for the subset of the cell groups based on the training data that includes data for the new cell;
evaluating the performance of the group ML models for the subset of the cell groups based on the evaluation data; and
selecting a cell group for the new cell among the cell groups in the subset based on the performance of the group ML models.
